(19) United States
(12) Patent Application Publication
(10) Pub. No.: US 2026/0339447 A1
(43) Pub. Date: Oct. 29, 2026

(54) METHOD AND SYSTEM FOR CONTROLLING AR DEVICE

(71) Applicant: VIRNECT CO., LTD., Seoul (KR)

(72) Inventors: Taejin HA, Seoul (KR); Jaemin PARK, Seoul (KR)

(21) Appl. No.: 19/426,205

(22) Filed: Dec. 19, 2025

(30) Foreign Application Priority Data
Dec. 20, 2024 (KR) 10-2024-0193352
Dec. 26, 2024 (KR) 10-2024-0196896
Feb. 3, 2025 (KR) 10-2025-0013147

(51) Int. Cl. G06F 3/038; G06F 3/01; G06F 3/04812; G06F 3/04815; G06F 3/04845; G06F 3/16; G10L 15/22; G10L 21/0232

(52) U.S. Cl. CPC G06F 3/038; G06F 3/012; G06F 3/013; G06F 3/04812; G06F 3/04815; G06F 3/04845; G06F 3/167; G10L 15/22; G10L 21/0232; G06F 2203/0381; G10L 2015/223

(57) ABSTRACT

The present disclosure relates to an AR device control method and system operating based on gaze and voice commands. The control method according to an embodiment of the present disclosure provides a multimodal interface that primarily selects a target by tracking a user's gaze and instructs a specific task through a voice command.

### CROSS-REFERENCE TO RELATED APPLICATIONS

This application claims priority under 35 U.S.C. § 119 (a) to Korean Patent Application No. 10-2024-0193352, filed on 2024 Dec. 20, Korean Patent Application No. 10-2024-0196896, filed on 2024 Dec. 26, and Korean Patent Application No. 10-2025-0013147, filed on 2025 Feb. 3. The entire disclosure of the above-identified application is hereby incorporated by reference herein in their entirety.

### TECHNICAL FIELD

The present disclosure relates to an augmented reality (AR) device control method and system. More specifically, the present disclosure relates to an AR device control method and system for controlling an artificial intelligence-based AR device based on the user's gaze and voice commands.

### BACKGROUND ART

Augmented reality (AR) and virtual reality (VR) technology, which is one extended reality (XR), has been drawing attention as technology for innovatively improving user experience.

However, when commands are performed on a virtual interface screen using such a technology, a user experiences various difficulties in selecting an object or a non-object (for example, a specific position in a background).

In particular, in a virtual reality environment, a separate controller is provided for precise selection, but in the augmented reality environment, there is no controller in many cases and such selection is particularly not easy. Also, recently, development has been progressing in a direction of not using a controller even in the virtual reality environment. Accordingly, user interface control in an AR device is inevitably limited. There have been attempts to control the AR device using means such as hand gestures, but there are disadvantages in that usability is low due to low accuracy of gesture recognition, and gesture input itself is not possible when, for example, a task is performed with hands.

Meanwhile, in order to execute an existing application based on a touch or input tool interface in an AR device, it is necessary to optimize the application for an extended reality environment, which requires many technical difficulties and costs. As a result, it is difficult to utilize a general application in an AR device such as smart glasses. Such limitations hinder utilization of the AR device and limit user experience.

An existing XR system (for example, RealWear) has interface-related difficulties in selecting or controlling a specific region or point in a virtual environment or an extended environment. There is a lack of a method capable of freely selecting and operating a specific region or point on a screen regardless of whether labeling is designated, whether an event is designated, and whether selection is possible through an AR device. This causes the user not to accurately select a desired position or object, thereby degrading user experience.

Therefore, there is a need for a new method capable of overcoming limitations of a separate controller or gesture recognition and allowing a user to select and control any point on a screen. In particular, there is a need for a technology that can be utilized without optimizing an existing application for an AR device.

Meanwhile, since a task environment in which an AR device is used is vulnerable to noise and a task is performed with both hands in many cases, gesture input is often difficult.

### RELATED ART DOCUMENT

### Patent Document

(Patent Literature 1) KR 10-1678009 B1

### DISCLOSURE

### Technical Problem

An aspect of the present disclosure has been made to solve the problems of the related art as described above, and an object thereof is to provide an artificial intelligence-based AR device control method and system based on user's gaze and voice commands.

However, the technical problem to be achieved by the present disclosure and embodiments of the present disclosure are not limited to the technical problems as described above, and other technical problems may exist.

### Technical Solution

According to an aspect of the present disclosure, a method in which a voice AI agent application executed by at least one processor of an AR device performs an AR device control method includes tracking a user's gaze to generate gaze tracking data; providing an object determination interface that determines an object according to the generated gaze tracking data; determining an object selected by the user according to the provided object determination interface; recognizing task instruction voice data for the determined object; and executing a task command for the object in response to the task instruction voice data.

Here, the gaze tracking data may include a gaze vector indicating left-eye and right-eye gaze directions of the user, a gaze intersection point calculated by intersection of the gaze vectors, and whether the gaze is maintained for a predetermined time.

The object determination interface may be configured to calculate, for a plurality of objects or screen regions displayed on an XR image or an external image with reference to the gaze intersection point, a positional relationship between position information or a center point of each object and the gaze intersection point, and to determine that an object or a screen region in which the positional relationship satisfies a preset condition is an object selected by the user.

Also, when a predefined object does not exist around the gaze intersection point, a screen coordinate area including the gaze intersection point may be set as a spatial entity candidate.

Also, the task instruction voice data may be converted into command data in a text form by a voice recognition model, and the command data in the text form may be interpreted as command information including an action, a target object, a spatial relationship, or a predetermined parameter using a natural language processing technique.

Also, the command information may be associated with object label information and function metadata stored in an XR image database and converted into a task command executable for the object.

Also, according to another aspect of the present disclosure, a method of performing AR device control by a voice AI agent application executed by at least one processor of an AR device includes constructing an AR image database including a labeling data set for an AR object that is an object that supports user interaction based on an augmented reality environment; acquiring voice AI agent task data including a predetermined AR image, external image, and voice command data; determining an AR target object that is the AR object corresponding to the voice AI agent task data; determining, based on the voice command data, a target spatial entity that is a spatial entity for the user interaction; providing an AR spatial object that is the AR object obtained by visualizing the target spatial entity; and executing a task command for the user interaction based on the AR spatial object.

### Advantageous Effects

In the AR device control method and system according to the aspect of the present disclosure, it is possible to precisely control the AR device intuitively and efficiently through voice without a separate controller or complex gestures by performing artificial-intelligence-based control of the AR device, based on the user's gaze and voice commands.

Further, in the AR device control method and system according to the aspect of the present disclosure, it is possible to recognize the user's voice commands quickly and accurately in an environment in which noise occurs.

In addition, in the AR device control method and system according to the aspect of the present disclosure, it is possible to ascertain the user's command intent quickly and accurately through the user's gaze and voice commands, thereby performing smooth control of smart glasses.

Accordingly, in the AR device control method and system according to the aspect of the present disclosure, it is possible to remarkably improve the quality of a user experience based on the augmented reality environment, and control performance.

However, the effects obtainable in the present disclosure are not limited to the effects mentioned above, and other effects that are not mentioned can be clearly understood from the description below.

### DESCRIPTION OF DRAWINGS

FIG. 1 is a conceptual diagram of an AR device control system according to an embodiment of the present disclosure.

FIG. 2 is an internal block diagram of a wearable-type computing device according to an embodiment of the present disclosure.

FIG. 3 is an internal block diagram of a mobile-type computing device according to an embodiment of the present disclosure.

FIG. 4 is an internal block diagram of a desktop-type computing device according to an embodiment of the present disclosure.

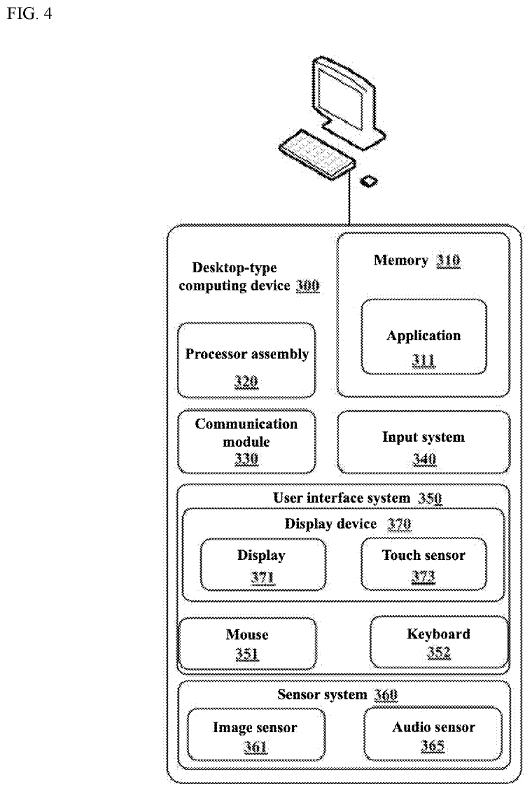

FIG. 5 is an internal block diagram of a table-top type computing device according to an embodiment of the present disclosure.

FIG. 6 is a flowchart showing an AR device control method according to an embodiment of the present disclosure.

FIG. 7 is an illustrative diagram showing voice AI agent task data according to an embodiment of the present disclosure.

FIG. 8 is an illustrative diagram showing a method of providing and editing an XR spatial object according to an embodiment of the present disclosure.

FIG. 9 is an illustrative diagram showing a method of providing and editing an XR external spatial object for an external image (EI) level task according to an embodiment of the present disclosure.

FIG. 10 is a flowchart showing a gaze- and voice-based AR device control method according to an embodiment of the present disclosure.

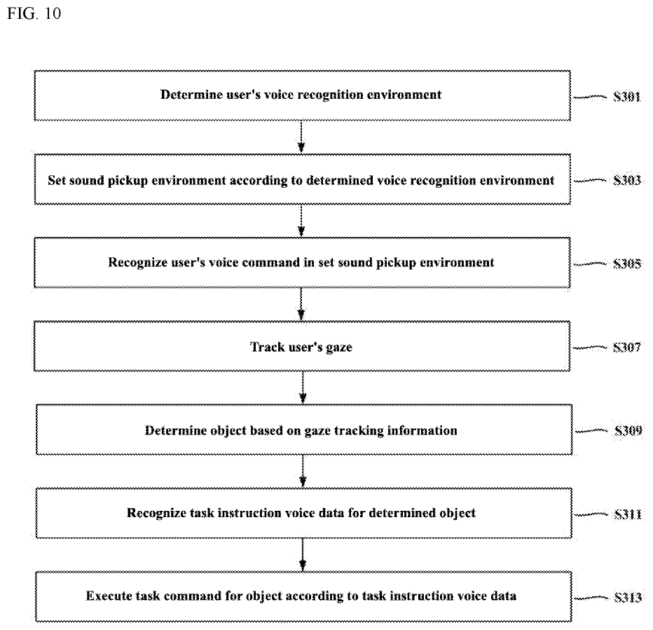

FIG. 11 illustrates a process of selecting an XR object according to a user's gaze according to an embodiment of the present disclosure.

### MODE FOR INVENTION

The present disclosure can have various modifications and various embodiments, and specific embodiments will be illustrated in the drawings and described in detail in the detailed description. The effects and features of the present disclosure, and methods for achieving these will become clear with reference to embodiments to be described in detail below together with the drawings. However, the present disclosure is not limited to the embodiments disclosed below and may be implemented in various forms. In the embodiments below, terms such as “first” and “second” are used not in a limiting sense but to distinguish one component from another component. Also, a singular expression includes a plural expression unless clearly meant differently in context. Also, terms such as “include” or “have” mean that features or components described in the specification exist, and do not preclude a likelihood that one or more other features or components may be added. Also, in the drawings, for convenience of description, components may be exaggerated or reduced in size. For example, sizes and thicknesses of respective components shown in the drawings are arbitrarily shown for convenience of description, and thus the present disclosure is not necessarily limited to what is shown.

Hereinafter, the embodiments of the present disclosure will be described in detail with reference to the accompanying drawings, the same or corresponding components are denoted by the same reference numerals when the components are described with reference to the drawings, and redundant description thereof will be omitted.

### AR Device Control System

An AR device control system according to an embodiment of the present disclosure may provide an AR device control method service that performs artificial intelligence-based AR device control based on a user's voice commands.

Such an AR device may generally provide an extended reality (XR) environment, an augmented reality (AR) environment, or a virtual reality (VR) environment.

Hereinafter, a case in which an AR device control method service is mainly provided in an AR environment will be described, but it will be obvious that the service may also be applied to a VR environment.

Such an AR device control system may provide an AR device control method service for performing AR device control based on the user's gaze and voice commands.

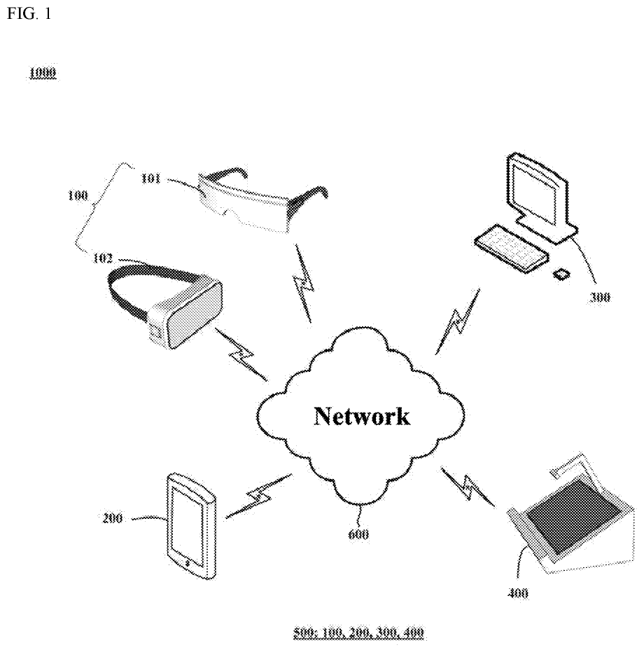

FIG. 1 is a conceptual diagram of an AR device control system according to an embodiment of the present disclosure.

Referring to FIG. 1, an AR device control system 1000 according to an embodiment of the present disclosure may include an AR device 500 and a network 600.

In this case, the network 600 means a connection structure in which information can be exchanged between respective nodes such as the AR device 500, and examples of the network 600 includes a 3rd generation partnership project (3GPP) network, a long term evolution (LTE) network, a world interoperability for microwave access (WIMAX) network, the Internet, a local area network (LAN), a wireless local area network (WLAN), a wide area network (WAN), a personal area network (PAN), a Bluetooth network, a satellite broadcasting network, an analog broadcasting network, a digital multimedia broadcasting (DMB) network, and the like, but are not limited thereto.

Hereinafter, the AR device 500 for implementing a method and system for controlling the AR device 500 will be described in detail with reference to the accompanying drawings.

### Augmented Reality Device (AR Device) 500

The AR device 500 according to the embodiment of the present disclosure may be a predetermined computing device in which a voice AI agent application 511 (111, 211, 311, or 411) that provides the service for controlling the AR device 500 are installed.

In general, the AR device 500 may be a technical device that provides an augmented experience by overlaying virtual digital information in real time on an environment of a real world.

In another embodiment, the AR device 500 may mean a technical device that provides a virtual experience in a virtual world.

Such an AR device 500 may be designed so that a user can recognize and interact with real-world and virtual data at the same time by combining hardware such as a camera, a sensor, a display, and/or a processor with software.

In an embodiment, the AR device 500 as described above may include various types (for example, a wearable type, a mobile type, a desktop type, and/or a table-top type) of computing devices in which the voice AI agent application 511 (111, 211, 311, and 411) is installed.

### 1. Wearable-Type Computing Device 100 (101 and 102)

The AR device 500 according to the embodiment of the present disclosure may include a wearable-type computing device 100 such as a predetermined smart glasses display 101 or a head mounted display (HMD) 102 in which an application 111 is installed.

The smart-glasses type computing device 101 may include a display system including glasses that transmit light so that the user can see a surrounding physical space during while being worn and display virtual content on a user's field of view.

Specifically, the computing device 101 of the embodiment may include a transparent glass display that transmits light from the surrounding physical space so that the light reaches the user's eyes, and reflects virtual content displayed by the display system toward the user's eyes.

In this case, the virtual content may include visual content such as an image or a video that can be displayed on a part of user's field of view in the smart-glasses type computing device 101.

For example, the virtual content may include virtual object images overlaid on various portions of a physical space. Such virtual object images may be rendered as a 2D image or a 3D image.

Meanwhile, a head mounted display type computing device 102 may block light for the surrounding physical space so that a displayed image can be seen only by the display system.

Such a head mounted display type computing device 102 may output different images having an offset in parallax to a left-eye display and a right-eye display in order to cause a three-dimensional scene to be recognized, thereby outputting a three-dimensional image and providing a virtual reality environment.

The head mounted display type computing device 102 may output, as a three-dimensional image, a video obtained by photographing the surrounding physical space and virtual content generated based on the captured video, thereby providing the augmented reality environment.

Hereinafter, specific components of the smart-glasses type computing device 101 among the wearable-type computing devices 100 will be described.

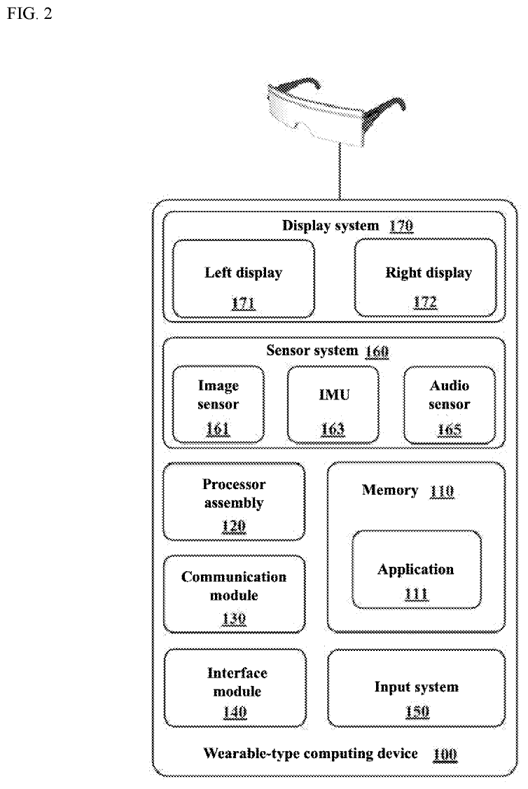

FIG. 2 is an internal block diagram of the wearable-type computing device 100 according to an embodiment of the present disclosure.

Referring to FIG. 2, the smart-glasses type computing device 101 according to an exemplary implementation may include a memory 110 including an application 111, a processor assembly 120, a communication module 130, an interface module 140, an input system 150, a sensor system 160, and a display system 170. Also, the components may be implemented to be included in a housing of the smart-glasses type computing device 101.

The application 111 is stored in the memory 110, and the application 111 may include, for example, virtual content, an image buffer, a position engine, and a virtual content display engine for providing the service for controlling the AR device 500.

That is, the memory 110 may store commands and data that can be used to provide the service for controlling the AR device 500.

Also, the memory 110 may include at least one or more non-transitory computer-readable storage media and transitory computer-readable storage media.

For example, the memory 110 may be any storage device such as a ROM, EPROM, a flash drive, or a hard drive, and may include a web storage that performs a storage function of the memory 110 on the Internet.

The processor assembly 120 may include at least one or more processors capable of executing commands of the application 111 stored in the memory 110 in order to perform various tasks for providing the service for controlling the AR device 500.

In an embodiment, the processor assembly 120 may control overall operations of the components through the application 111 of the memory 110 in order to provide the service for controlling the AR device 500.

For example, the processor assembly 120 may recognize a real object from a video acquired based on a predetermined image sensor, and control components of the smart-glasses type computing device 101 so that the components can generate and display an augmented reality video in which virtual content is matched with the recognized real object.

Such a processor assembly 120 may include a central processing unit (CPU) and/or a graphics processor unit (GPU). Also, the processor assembly 120 may be implemented to include at least one of application specific integrated circuits (ASICs), digital signal processors (DSPs), digital signal processing devices (DSPDs), programmable logic devices (PLDs), field programmable gate arrays (FPGAs), controllers, micro-controllers, microprocessors, and other electrical units for performing functions.

The communication module 130 may include one or more devices for communicating with another AR device 500. Such a communication module 130 may communicate through a wireless network.

In an embodiment, the communication module 130 may communicate with the AR device 500 that stores a virtual content source for providing the service for controlling the AR device 500, and may communicate with various user input components such as a controller that receives user input.

In an embodiment, the communication module 130 may transmit and receive various types of data related to the service for controlling the AR device 500 to and from another AR device 500.

Such a communication module 130 may transmit and receive data wirelessly to and from at least one of a base station, an external terminal, and an arbitrary server on a mobile communication network configured through a communication device capable of performing technical standards or communication schemes for mobile communication (for example, long term evolution (LTE), long term evolution-advanced (LTE-A), new radio (5G NR), or WIFI), a short-range communication scheme, or the like.

The sensor system 160 may include various sensors such as an image sensor 161, a position sensor (IMU) 163, an audio sensor, a distance sensor, a proximity sensor, or a contact sensor.

The image sensor 161 may capture an image and/or a video for a physical space around the smart-glasses type computing device 101.

In an embodiment, the image sensor 161 may capture and acquire a video related to the service for controlling the AR device 500.

Also, the image sensor 161 may be disposed on a front surface and/or a rear surface of the smart-glasses type computing device 101 to photograph a region in a disposition direction and acquire a video, and may photograph a physical space such as a work site through a camera disposed toward the outside of the smart-glasses type computing device 101.

Such an image sensor 161 may include the image sensor 161 and an image processing module. Specifically, the image sensor 161 may process a still image or a moving image obtained by the image sensor 161 (for example, a CMOS or CCD).

Also, the image sensor 161 may use the image processing module to process the still image or moving image acquired through the image sensor 161, extract necessary information, and deliver the extracted information to the processor.

Such an image sensor 161 may be a camera assembly including at least one or more cameras. The camera assembly may include a general camera that photographs a visible light band, and may further include a special camera such as an infrared camera or a stereo camera.

The IMU 163 may sense at least one or more of movement and acceleration of the smart-glasses type computing device 101. For example, the IMU 163 may include a combination of various position sensors such as an accelerometer, a gyroscope, and a magnetometer.

Also, spatial information of the physical space around the smart-glasses type computing device 101 may be recognized by interworking with a position communication module 130 such as a GPS of the communication module 130.

Also, the IMU 163 may detect information for detecting and tracking the user's gaze direction and head movement based on a detected position and direction.

Also, in some implementations, using the IMU 163 and the image sensor 161, the application 111 may determine the user's position and direction in the physical space or recognize features or objects in the physical space.

An audio sensor 165 may recognize sound around the smart-glasses type computing device 101.

Specifically, the audio sensor 165 may include a microphone capable of sensing a voice input of a user of the smart-glasses type computing device 101.

In an embodiment, the audio sensor 165 may receive, from the user, voice data of communication data to be transmitted through an augmented reality-based communication service.

The interface module 140 may communicably connect the smart-glasses type computing device 101 to one or more other devices.

Specifically, the interface module 140 may include a wired and/or wireless communication device compatible with one or more different communication protocols.

The smart-glasses type computing device 101 may be connected to various input and output devices via such an interface module 140.

For example, the interface module 140 may be connected to an audio output device such as a headset port or a speaker, for audio output.

Although an example in which the audio output device is connected through the interface module 140 has been described, an embodiment in which the audio output device is installed inside the smart-glasses type computing device 101 may also be included.

Such an interface module 140 may include at least one of a wired/wireless headset port, an external charger port, a wired/wireless data port, a memory card port, a port for connecting a device including an identification module, an audio input/output (I/O) port, a video I/O port, an earphone port, a power amplifier, an RF circuit, a transceiver, and other communication circuits.

The input system 150 may sense a user input (for example, a gesture, a voice command, operation of a button, or another type of input) related to the service for controlling the AR device 500.

Specifically, the input system 150 may include a button, a touch sensor, and the image sensor 161 that receives a user motion input.

Also, the input system 150 may be connected to an external controller through the interface module 140 to receive the input from the user.

The display system 170 may include a transparent glass display that transmits light from a physical space around the smart-glasses type computing device 101 so that the light reaches the user's eyes, and reflects virtual content displayed by the display system 170 toward the user's eyes.

Such a display system 170 may include a left display 171 corresponding to a left eye of the user wearing the smart-glasses type computing device 101, and a right display 172 corresponding to a right eye of the user, and the left display 171 and the right display 172 may output different images having an offset in parallax as virtual content, so that the user can recognize the virtual content as a three-dimensional image.

In an embodiment, the display system 170 may output various types of information related to the service for controlling the AR device 500 as a graphic image.

Such a display may include at least one of a liquid crystal display (LCD), a thin film transistor-liquid crystal display (TFT LCD), an organic light-emitting diode (OLED), a flexible display, a three-dimensional (3D) display, and an e-ink display.

### 2. Mobile-Type Computing Device 200

The AR device 500 according to the embodiment of the present disclosure may include a mobile-type computing device 200 such as a smart phone smart phone, a mobile phone, a terminal for digital broadcasting, a personal digital assistant (PDA), a portable multimedia player (PMP), or a tablet PC, in which an application 211 is installed.

Such a mobile-type computing device 200 may capture a video of the surrounding physical space using the image sensor, and display, through the display system, the captured video and virtual content matched with the physical space, thereby providing the augmented reality environment to the user.

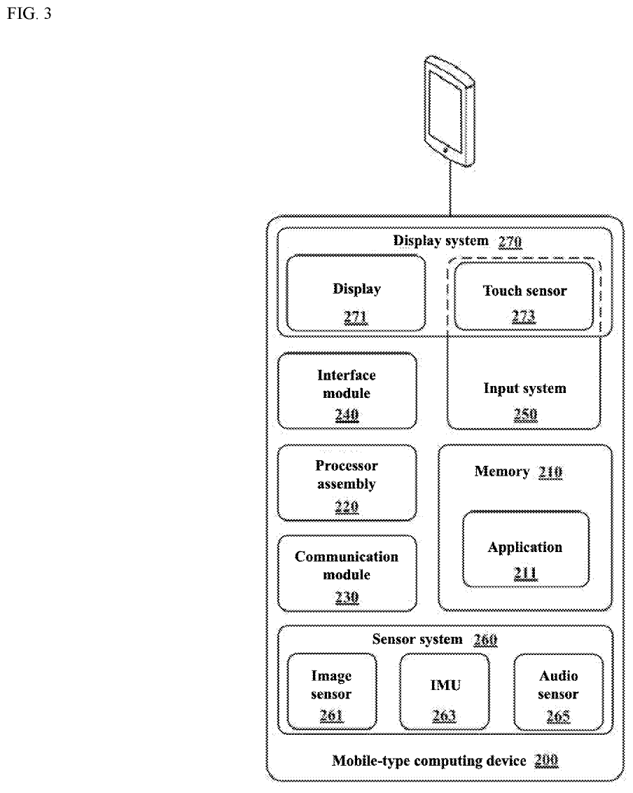

FIG. 3 is an internal block diagram of the mobile-type computing device according to an embodiment of the present disclosure.

Referring to FIG. 3, the mobile-type computing device 200 according to an exemplary implementation may include a memory 210, a processor assembly 220, a communication module 230, an interface module 240, an input system 250, a sensor system 260, and a display system 270. These components may be configured to be included in a housing of the computing device 200.

In description of the components of the mobile-type computing device 200, duplicated content is replaced with the description of the components of the smart-glasses type computing device 101, and hereinafter, differences from the smart-glasses type computing device 101 will be mainly described.

The components may be disposed in the housing of the mobile-type computing device 200, and a user interface may include a touch sensor 273 on a display 271 configured to receive a user touch input.

Specifically, the display system 270 may include the display 271 that outputs an image and a touch sensor 273 that senses a user's touch input.

For example, the display 271 may be implemented as a touch screen by forming a layer structure with the touch sensor 273 or being integrally formed with the touch sensor 273. Such a touch screen may function as a user input unit that provides an input interface between the computing device 200 and the user, and also provide an output interface between the computing device 200 and the user.

Also, the sensor system 260 may include an image sensor 261, and, for example, the image sensor 261 may be disposed on one side surface and the other side surface of the housing of the computing device 200.

In this case, the image sensor on the one side surface may be oriented toward the physical space to capture a video obtained by photographing the physical space, and the image sensor on the other side surface may be oriented toward the user side to photograph the user's field of view, gestures, and the like

Also, the input system 250 may sense an input from the user (for example, a gesture, a voice command, operation of a button, or another type of input) related to the service for controlling the AR device 500.

Specifically, the input system 250 may include a button, a joystick, a touch sensor, and the image sensor 161 that receives a user motion input.

Also, the input system 250 may be connected to an external controller through the interface module 240 to receive the input from the user.

### 3. Desktop-Type Computing Device 300

The AR device 500 according to the embodiment of the present disclosure may include a desktop-type computing device 300 such as a predetermined fixed desktop PC, laptop computer, ultrabook computer, or a personal computer, in which an application 311 is installed. Such a desktop-type computing device 300 may receive a video obtained by

photographing a surrounding physical space from the AR device 500 of another user, and augment and display the received video and virtual content matched to the physical space, thereby providing the service for controlling the AR device 500 to the user.

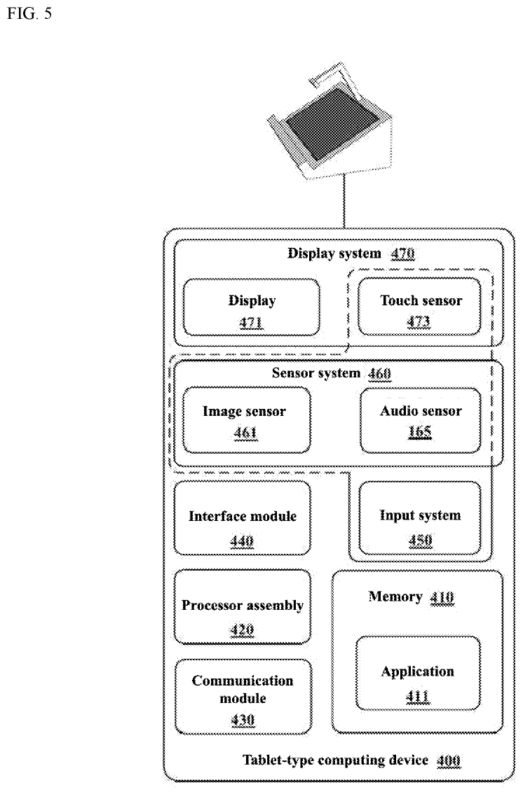

FIG. 5 is an internal block diagram of the desktop-type computing device 300 according to an embodiment of the present disclosure.

Referring to FIG. 5, the desktop-type computing device 300 according to an exemplary implementation may include a memory 310, a processor assembly 320, a communication module 330, a user interface system 350, and an input system 340. These components may be configured to be included in a housing of the desktop-type computing device 300.

Among descriptions of the components of the desktop-type computing device 300, duplicated content is replaced with the description of components of the smart-glasses type computing device 101, and hereinafter, differences from the smart-glasses type computing device 101 will be mainly described.

Specifically, the desktop-type computing device 300 may include the user interface system 350 to receive user inputs (for example, touch input, mouse input, keyboard input, gesture input, and motion input using a guide tool).

For example, the desktop-type computing device 300 may be connected to at least one device such as a mouse 351, a keyboard 352, a gesture input controller, an image sensor 361 (for example, a camera), and an audio sensor 365 using various communication protocols via the user interface system 350, to acquire user input.

Also, the desktop-type computing device 300 may be connected to an external output device through the user interface system 350, and may be connected to, for example, a display device 370, an audio output device, and the like.

### 4. Table-Top Type Computing Device 400

The AR device 500 according to the embodiment of the present disclosure may include a table-top type computing device 400 in which an application 411 is installed.

In an embodiment, the table-top type computing device 400 may be implemented in a table-top form having a new shape and structure different from an existing desktop-type computing device 300, and in this case, the service for controlling the AR device 500 may be provided through a system included in a table-top.

Specifically, the table-top type computing device 400 may be a device that provides an interface system that allows a remote first user (for example, a remote manager) to easily check a video received from the AR device 500 of a second user (for example, an on-site worker) and to easily input task guidance for an object displayed in the video based on virtual content.

That is, the table-top type computing device 400 may provide the augmented reality environment to the user by outputting a captured video acquired from the AR device 500 of the other user and virtual content associated with the captured video through a predetermined display system.

Hereinafter, in description of the components of the table-top type computing device 400, duplicated content is replaced with the description of the components of the desktop-type computing device 300, and hereinafter, differences from the desktop-type computing device 300 will be mainly described.

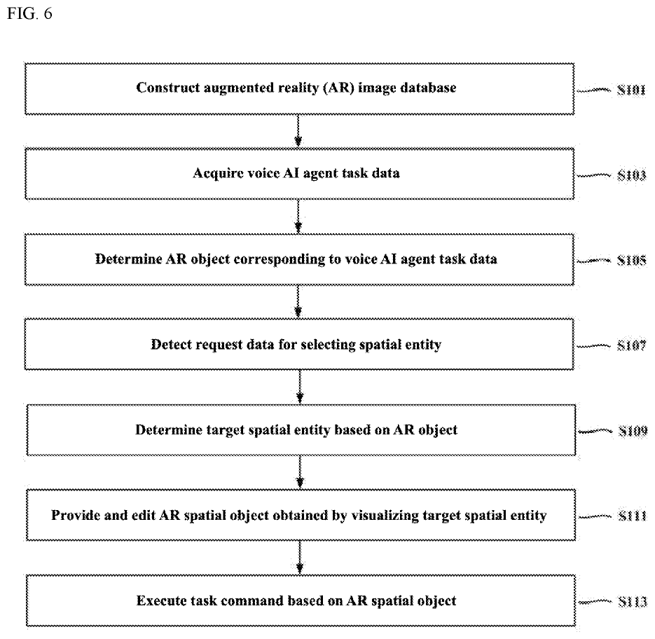

FIG. 6 is an internal block diagram of the table-top type computing device according to an embodiment of the present disclosure.

Referring to FIG. 6, the exemplary table-top type computing device 400 may include a memory 410, a processor assembly 420, a communication module 430, an interface module 440, an input system 450, a sensor system 460, and a display system 470. Such components may be configured to be included in a housing of the computing device 400.

Also, the table-top type computing device 400 may provide an input and output interface that receives touch inputs such as pointing and dragging of the user with respect to a captured video through a touch sensor 473 on a display 471 of the display system 470.

Also, the table-top type computing device 400 may receive gesture input of the user's hands through the sensor system 460 (for example, an image sensor 461) disposed on the display system 470, and may receive motion input via a guide tool. Such gesture input and motion input via the guide tool may also be input in correspondence with the captured video on the display 471, and the table-top type computing device 400 may detect the user input by matching the user input with a real object image displayed in the captured video.

That is, the application 411 of the table-top type computing device 400 according to the embodiment may execute a series of processes for implementing a service for visualizing and providing virtual content based on the user input acquired through the sensor system 460. In this case, an input and output interface capable of performing the user input in correspondence with the captured video displayed on the display is provided so that the user can more intuitively perform the input for the captured video.

Meanwhile, the AR device 500 according to the embodiment of the present disclosure may perform deep learning related to the service for controlling the AR device 500 based on a predetermined deep-learning neural network.

Here, the deep-learning neural network according to the embodiment may include, for example, a recurrent neural network (RNN), a long short-term memory (LSTM), a gated recurrent unit (GRU), DeepSpeech, Wav2Vec, a convolution-augmented transformer (Conformer), a convolution neural network (CNN), a deep plane sweep network (DPSNet), a pyramid scene parsing network (PSPNet), an attention guided network (AGN), regions with CNN features (R-CNN), Fast R-CNN, Faster R-CNN, Mask R-CNN, DualStyleGAN, DeepLab (V2, V3, V3+), SegNet, U-Net, AlexNet, VGGNet, residual network (ResNet) and/or EfficientNet network, but is not limited thereto.

In an embodiment, the AR device 500 may perform, for example, voice recognition deep-learning by interworking with the predetermined deep-learning neural network as described above.

### AR Device (500) Control Method

Hereinafter, a method in which the voice AI agent application 511 (hereinafter, an application) executed by at least one processor 120, 220, 320, or 420 of the AR device 500 according to the embodiment of the present disclosure provides the service for controlling the AR device 500 will be described in detail with reference to the accompanying drawings.

In an embodiment of the present disclosure, the at least one processor 120, 220, 320, or 420 of the AR device 500 may execute at least one application 511 stored in at least one memory 110, 210, 310, or 410 or may operate the application 511 in a background state.

Hereinafter, a case in which the method of providing the service for controlling the AR device 500 by the at least one processor 120, 220, 320, or 420 of the AR device 500 operating to execute instructions of the application 511 is performed by the application 511 will be described.

FIG. 6 is a flowchart showing an AR device 500 control method according to the embodiment of the present disclosure.

Referring to FIG. 6, in an embodiment, the application 511 executed by the at least one processor 120, 220, 320 or 420 of the AR device 500 or operating in a background state may construct an augmented reality image database (XR image database) (S101).

Here, the XR image according to an embodiment may mean a visual element that shows predetermined digital content (for example, an image, a graphic, and/or a three-dimensional model) superimposed on an environment of the real world through augmented reality technology.

In an embodiment, the XR image may include virtual content (for example, a main screen, a sub-screen, and/or an XR object) provided through the AR device 500.

Such an XR image may be implemented in a form in which virtual elements are mixed with the real world by being superimposed and displayed on a video representing the real world, and this makes it possible to realize interaction with virtual content while viewing the real world.

In another embodiment, the XR image may output a virtual space environment for a virtual world through virtual reality technology and providing predetermined interactive digital content (for example, an image, a graphic, and/or a three-dimensional model) in the virtual world.

Hereinafter, an AR environment will be mainly described, but it may be understood that such a technology is applied in the same manner even in a VR environment by replacing a real world with a virtual world.

Specifically, in an embodiment, the application 511 may construct an XR image database including a data set based on the XR images as described above.

More specifically, in an embodiment, the application 511 may perform labeling for a predetermined XR image.

The labeling for each XR image may include generating metadata including a position, a shape, a size, and availability of interaction of an object included in each XR image.

The metadata may be used as reference data in a voice command interpretation or object selection process, and may be used as basic data for object recognition or command matching.

Also, the XR image database may be configured to include a relative positional relationship or a functional association relationship between objects in the XR image.

In an embodiment, the application 511 may identify an object included in each XR image (including an XR object in the embodiment), and collect text label information (for example, text data for specifying a name, a function, a color, a shape, a form, and/or a manufacturer) for the identified object. Here, the XR object may mean an XR object capable of interaction according to the input from the user.

For example, the application 511 may detect a first icon from a predetermined XR image and then crawl and/or scrape a web page link related to the first icon (for example, a first icon introduction page link) to collect text label information for the first icon.

Also, in an embodiment, the application 511 may match the collected text label information to each corresponding XR image to construct a database.

Accordingly, the application 511 may construct an XR image database including a labeled XR image data set.

This makes it possible for the application 511 to provide an environment in which a specific object in the XR image can be appropriately identified, selected, and processed in response to a predetermined voice command.

Meanwhile, according to an embodiment, the application 511 may define relationships (for example, position, size, and/or associated function) between objects in the XR image included in the XR image database, and may further include the relationships in the XR image database.

This makes it possible for the application 511 to allow respective objects to operate more accurately in various task contexts.

Also, the application 511 according to an embodiment of the present disclosure may acquire voice AI agent task data (S103).

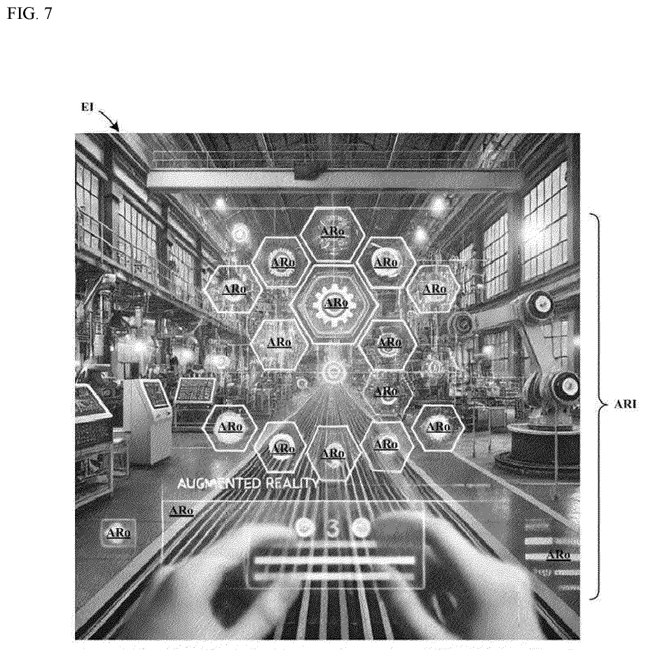

FIG. 7 is an illustrative diagram showing the voice AI agent task data according to an embodiment of the present disclosure.

Here, referring to FIG. 7, the voice AI agent task data according to the embodiment may mean a set of data required to perform the service for controlling the AR device 500, which is obtained by integrating, for example, a predetermined XR image XRI, external image EI, voice command, and/or context data.

Specifically, in an embodiment, the voice AI agent task data may include the predetermined XR image XRI, external image EI, voice command, and/or context data.

Here, again, the XR image XRI according to the embodiment may be data including virtual content provided through the AR device 500, and may provide information on a virtual environment currently displayed on a screen.

Also, the external image EI according to the embodiment may be data including an image of the real world shown through the AR device 500, and may provide information on a physical external environment.

In another embodiment, the external image EI may be understood as a background image representing a virtual world shown through the AR device 500.

Also, the voice command data according to the embodiment may be data for specifying a voice command that a predetermined user utters in order to interact with the AR device 500, and may provide an intent of the command and information on a context.

Such voice command data may include data obtained by converting the voice command into text.

Also, the context data according to the embodiment may be data including metadata related to a predetermined task environment for the service for controlling the AR device 500, and may provide information such as a context of a conversation, a currently performed task, and/or a display state in the XR image XRI.

Specifically, in an embodiment, the application 511 may acquire the voice AI agent task data as described above by interworking with, for example, the predetermined sensor system 160, 260, 360, or 460 and/or the input system 150, 250, 340, or 450.

This makes it possible for the application 511 to acquire base data for converting a user's voice command into an executable and contextually appropriate task.

Accordingly, the application 511 may clearly interpret an intent according to the user's voice command and may easily implement the control of the AR device 500.

Specifically, the application 511 may determine the object or the spatial entity by integrating an object selection result based on gaze tracking data, an object candidate based on voice command data, and an object recognition result on the XR image or the external image.

In this case, each result may be considered complementarily according to a current task context or environment information.

Also, the application 511 according to an embodiment of the present disclosure may determine the XR object (XRO) corresponding to the voice AI agent task data (S105).

Here, referring back to FIG. 7, the XR object (XRO) according to the embodiment may be an object designed to support user interaction in the augmented reality environment.

That is, in an embodiment, the XR object (XRO) may include elements preset to perform a specific function (for example, screen switching, information provision, and/or task execution) through user interaction based on the XR image XRI.

In an embodiment, as described above in step S101, the text label information corresponding to each XR object (XRO) may be pre-matched and stored and managed in the XR image database.

Specifically, the XR object (XRO) according to the embodiment may include, for example, a predetermined user interface element (UI element) and/or an icon.

Here, the UI element according to the embodiment may mean all graphic elements with which the user can interact through the augmented reality environment.

Meanwhile, the icon according to the embodiment may mean an object configured based on at least one UI element to intuitively deliver a specific task or information.

Specifically, in an embodiment, the application 511 may detect the XR object (XRO) corresponding to the voice command and/or the context data included in the voice AI agent task data on the XR image XRI and/or the external image EI included in the voice AI agent task data.

In an embodiment, the application 511 may detect at least one XR object (XRO) existing on the XR image XRI and/or the external image EI as an initial candidate XR object.

Also, the application 511 may extract text label information for each of the initial candidate XR objects detected as described above from the XR image database.

Also, the application 511 may compare the extracted text label information for each initial candidate XR object with the voice command data of the voice AI agent task data to identify at least one initial candidate XR object (hereinafter, a corresponding initial XR object) corresponding to the voice command data.

Also, the application 511 may analyze the context data (for example, a context of a conversation, a currently performed task, and/or a display state in the XR image XRI) and select the XR object (XRO) having the highest relevance to a current context from among the corresponding initial XR object.

The application 511 may determine that the selected XR object (XRO) as an XR object corresponding to the voice AI agent task data (hereinafter, an XR target object).

Also, the application 511 according to an embodiment of the present disclosure may detect spatial entity selection request data (S107).

Here, the spatial entity according to the embodiment may be a spatial element that a user can designate or interact with, such as specific coordinates (position), region, or object (including the XR object (XRO)) on at least one of the XR image XRI and the external image EI.

The spatial entity may be expressed by at least one of an object-based coordinate system defined based on an XR object and a device-based coordinate system defined based on an AR device.

The object-based coordinate system may be defined as relative position information with reference to a display region or a bounding region of the XR object, and relative position information included in a voice command may be converted into the coordinate system for calculation of a target spatial entity.

Meanwhile, spatial entity selection request data according to the embodiment may be data for explicitly indicating a request (intent) from a user desiring to select a predetermined spatial entity.

Specifically, in an embodiment, the application 511 may detect the spatial entity selection request data from the voice command data of the voice AI agent task data.

For example, the application 511 may detect spatial entity selection request data including a direct voice command for spatial entity selection such as “I want to select a spatial entity” from the voice command data.

Also, the application 511 according to an embodiment of the present disclosure may determine the target spatial entity based on the XR object (XRO) (TXRget Spatial Entity) (S109).

Here, the target spatial entity according to the embodiment may mean a spatial entity (spatial element) identified and designated to perform a specific interaction by reflecting the request from the user.

That is, in an embodiment, the target spatial entity may be, for example, a spatial reference point and/or region that becomes a center for execution of an interaction desired by the user.

Specifically, in an embodiment, the application 511 detecting the spatial entity selection request data may acquire the spatial entity setting audio data by interworking with the predetermined sensor system 160, 260, 360, or 460 and/or the input system 150, 250, 340, or 450.

Here, the spatial entity setting audio data according to the embodiment may mean voice command data additionally collected from the user to identify and designate the target spatial entity.

In an embodiment, the application 511 may acquire the spatial entity setting audio data for setting the target spatial entity with reference to the XR object corresponding to the voice AI agent task data (that is, the XR target object).

More specifically, in an embodiment, the application 511 may acquire a natural language voice input (that is, the spatial entity setting audio data) for designating predetermined coordinates (position) and/or region with reference to on the XR target object.

For example, the application 511 may acquire the natural language voice input for designating the predetermined coordinates (position) and/or region with reference to the XR target object, such as “2 cm above the XR target object,” “Select a region with a radius of 3 cm centered on the XR target object,” “Draw a circle having a diameter of 5 cm inside the XR target object,” or “Designate a rectangle including the upper side and both lateral sides of the target object.”

According to an embodiment, the application 511 may provide a guide for designating the predetermined coordinates (position) and/or region based on the XR target object, and may acquire the natural language voice input (that is, the spatial entity setting audio data) for designating the predetermined coordinates (position) and/or region based on the provided guide.

In an embodiment, the application 511 may provide an XR image (hereinafter, XR guide image) showing a guide for designating the predetermined coordinates (position) and/or region with reference to the XR target object.

For example, the application 511 may provide an XR guide image showing a grid-type coordinate (position) selection guide with reference to the XR target object.

Also, in an embodiment, the application 511 may acquire the natural language voice input for designating the predetermined coordinates (position) and/or region based on the XR guide image.

For example, the application 511 may acquire natural language voice input related to designating coordinates (position), such as “Select the second cell at the upper right in the grid,” “Designate the lower-left corner in the central grid,” or “Designate the second cell in the third row from the right of the grid.”

In another example, the application 511 may acquire natural language voice input related to designating a region, such as “Select the four center cells of the grid,” “Designate a region from the upper-left corner to the lower-right corner,” “Select both the first row and second row in the grid,” or “Group four adjacent cells into a square in the grid.”

In still another example, the application 511 may acquire natural language voice input including relative positions, such as “Select a region of three cells above on the XR target object,” “Designate a rectangle surrounding the grid around the XR target object,” “Select a grid corresponding to two cells to the right and one cell downward from the current position,” or “Select a region of three cells starting from a position immediately below the XR target object.”

As described above, in an embodiment, the application 511 may acquire the spatial entity setting audio data based on the XR target object and/or the XR guide image.

Also, in an embodiment, the application 511 may determine the target spatial entity based on the spatial entity setting audio data.

That is, the application 511 may interpret a natural language voice command according to the spatial entity setting audio data to target a predetermined spatial entity within the spatial entity on at least one of the XR image XRI and the external image EI.

In an embodiment, the processor may perform conversion between a user-centered coordinate system and a world coordinate system in order to determine the spatial entity. For example, when the user issues a voice command “a point located 10 cm to the right from the current gaze,” the processor may obtain a gaze collision point on the world coordinate system through a ray casting scheme.

Subsequently, the processor may calculate, through a cross product, a right vector and an upward vector perpendicular to a gaze vector with reference to the user's head direction. Also, the processor may calculate center coordinates of the target spatial entity by using a calculated basis vector and a distance value extracted from the voice command.

P_{target}=P_{gaze}+( [symbol] _{right}×10 cm) [Equation 3]

Further, the processor may generate a geometric volume according to shape information (for example, a circular region) extracted from the voice command with reference to the calculated center coordinate, and instantiate the geometric volume as a virtual interactive entity. Such coordinate conversion logic makes it possible for the user to perform an interaction such as designating a specific point, assigning a function, or leaving a memo even for an empty space in which a physical object does not exist.

Accordingly, in an embodiment, the application 511 may determine the target spatial entity according to a spatial entity targeted based on the spatial entity setting audio data.

Thus, in the embodiment, with the application 511, it is possible to select any location on an entire screen provided through the AR device 500 and perform corresponding interaction (for example, execution of a specific function operation, control, or action), only by voice input from the user, regardless of whether labeling is designated, whether an event is designated, or whether the AR device 500 is optimized.

This makes it possible for the application 511 to support easily performing, through voice input, a precise spatial entity setting even in a case in which the precise spatial entity setting is required, such as changing a size, position, and/or shape of an entire screen of the XR image XRI, changing a size, position, and/or shape of the UI element, or selecting and changing a UI element within a specific icon.

In particular, through this, even when there is a UI element that is authored for a heterogeneous UI device (for example, a smart phone, a tablet, a desktop, and/or a notebook) other than the AR device 500 and is not optimized for the AR device 500, which makes it difficult to select the UI element in the augmented reality environment, the application 511 may accurately select the UI element to perform interaction through the scheme described above.

Also, the application 511 according to an embodiment of the present disclosure may provide and edit an XR spatial object obtained by visualizing the target spatial entity (S111).

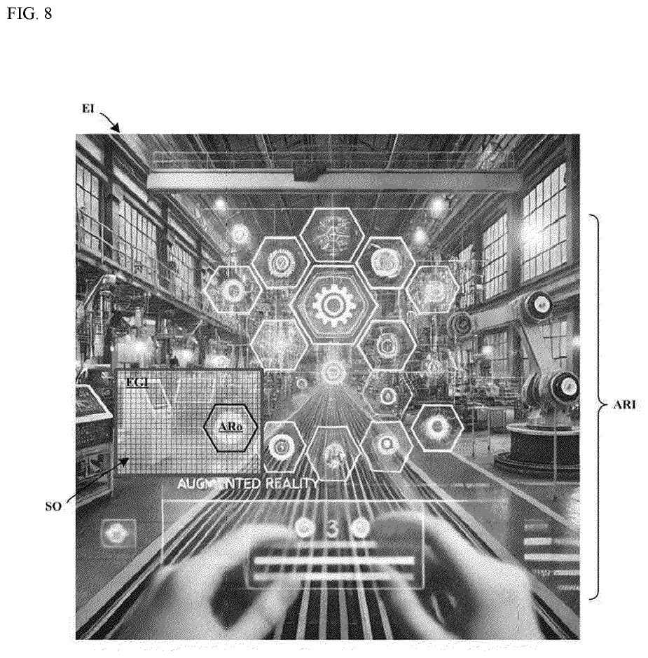

FIG. 8 is an illustrative diagram showing a method of providing and editing an XR spatial object according to an embodiment of the present disclosure.

That is, referring to FIG. 8, in an embodiment, the application 511 determining the target spatial entity may provide the XR spatial object SO, which is the XR object (XRO) obtained by visualizing the target spatial entity.

In an embodiment, the application 511 may provide the XR spatial object SO showing the target spatial entity in a form of a predetermined pointer and/or a region (for example, a rectangular shape or a circular shape).

Also, in an embodiment, the application 511 may acquire spatial entity editing audio data in conjunction with the predetermined sensor system 160, 260, 360, or 460 and/or the input system 150, 250, 340, or 450.

Here, the spatial entity editing audio data according to the embodiment may mean voice command data additionally collected from the user in order to edit the target spatial entity.

In an embodiment, the application 511 may acquire the spatial entity editing audio data for setting a position, a size, a shape, and/or detailed attributes of the XR spatial object SO.

Specifically, in an embodiment, the application 511 may acquire the natural language voice input (that is, the spatial entity editing audio data) for setting, for example, the position, size, shape, and/or detailed attribute of the XR spatial object SO.

For example, the application 511 may acquire the natural language voice input for setting, for example, the position, size, shape, and/or detailed attribute of the XR spatial object SO, such as “Move the XR spatial object SO upward by 5 cm,” “Make the XR spatial object SO larger by 1 cm in all directions,” “Reduce the XR spatial object SO by half,” “Change the XR spatial object SO into a square,” “Make corners of the XR spatial object SO rounded,” “Increase transparency of the XR spatial object SO,” “Change the color of the XR spatial object SO to black,” or “Make an outline thickness of the XR spatial object SO smaller.”

According to an embodiment, the application 511 may provide a guide for designating, for example, a predetermined position, size, shape, and/or detailed attribute with reference to the XR spatial object SO, and acquire the natural language voice input (that is, the spatial entity editing audio data) for designating, for example, the predetermined position, size, shape, and/or detailed attribute based on the provided guide.

In an embodiment, the application 511 may provide an XR image (hereinafter, XR editing guide image; EGI) showing a guide for designating, for example, the predetermined position, size, shape, and/or detailed attribute with reference to the XR spatial object SO.

For example, the application 511 may provide the XR editing guide image EGI showing, for example, a grid-type coordinate (position) selection guide with reference to the XR spatial object SO.

In addition, in an embodiment, the application 511 may acquire the natural language voice input for designating, for example, the predetermined position, size, shape, and/or detailed attribute of the XR spatial object SO based on the XR editing guide image EGI.

For example, the application 511 may acquire natural language voice input for setting, for example, the position, size, shape, and/or detailed attribute of the XR spatial object SO based on the XR editing guide image EGI, such as “Move two cells to the right from the current position,” “Make the XR spatial object SO larger by two cells in a vertical direction,” or “Move the XR spatial object SO to an upper-left corner of a grid.”

As described above, in an embodiment, the application 511 may acquire the spatial entity editing audio data based on the XR target object and/or the XR guide image.

Also, in an embodiment, the application 511 may edit the XR spatial object SO based on the spatial entity editing audio data.

That is, the application 511 may interpret the natural language voice command according to the spatial entity editing audio data to set, for example, the position, size, shape, and/or detailed attribute of the XR spatial object SO, thereby editing the target spatial entity corresponding thereto.

Thus, in the embodiment, the application 511 may provide a visual tool (that is, the XR spatial object SO) for visualizing the target spatial entity so that the user can clearly recognize and interact with a designated target spatial entity. Further, in an embodiment, the application 511 may intuitively and precisely adjust, for example, a position, a size, a shape, and/or detailed attributes of the target spatial entity using an editing function for the XR spatial object SO, thereby further improving interaction flexibility, efficiency, and quality of user experience in the augmented reality environment.

Also, the application 511 according to an embodiment of the present disclosure may execute a task command based on the XR spatial object SO (S113).

Specifically, in the embodiment, the application 511 may execute various task commands based on the XR spatial object SO.

More specifically, in an embodiment, the application 511 may acquire the task instruction audio data in conjunction with the predetermined sensor system 160, 260, 360, or 460 and/or the input system 150, 250, 340, or 450.

Here, the task instruction audio data according to an embodiment may mean voice command data of a user for specifying a task to be executed based on the XR spatial object SO.

In an embodiment, the task instruction audio data may include voice command data for specifying, for example, a predetermined shape modification task, element level task, and/or external image (EI) level task based on the XR spatial object SO.

Specifically, in an embodiment, the application 511 may execute a shape modification task based on the XR spatial object SO.

Here, the shape modification tasks according to an embodiment may include various tasks for modifying a shape of a predetermined XR object (XRO) based on the XR spatial object SO (for example, position movement and/or appearance adjustment).

Specifically, in an embodiment, the application 511 may acquire the task instruction audio data for specifying the predetermined shape modification task based on the XR spatial object SO.

In addition, in an embodiment, the application 511 may interpret the natural language voice command according to the acquired the task instruction audio data to execute the shape modification task based on the XR spatial object SO described above.

For example, the application 511 may execute the shape modification task for performing, for example, movement, resizing, rotation, and/or deformation on the predetermined XR object (XRO) using the XR spatial object SO in response to the task instruction audio data.

Thus, in an embodiment, the application 511 may adjust the XR object (XRO) using the XR spatial object SO in accordance with the user's need and preference, thereby improving task flexibility and providing a user-tailored augmented reality environment to enhance interaction convenience and satisfaction.

In addition, in an embodiment, the application 511 may execute an element level task based on the XR spatial object SO.

Here, the element level task according to an embodiment may include various tasks for performing preset specific functions on the predetermined XR object (XRO) based on the XR spatial object SO (including UI elements and/or icons in the embodiment).

Specifically, in an embodiment, the application 511 may acquire the task instruction audio data for specifying the predetermined element level task based on the XR spatial object SO.

In addition, in an embodiment, the application 511 may interpret the natural language voice command according to the acquired the task instruction audio data to execute the element level task based on the XR spatial object SO described above.

For example, the application 511 may execute the element level task for performing, for example, preset screen switching, information provision, and/or task execution on the predetermined XR object (XRO) included in the XR spatial object SO.

Accordingly, the application 511 may support detailed interaction control through voice commands.

In this case, in an embodiment, even when the XR object (XRO) is authored for the heterogeneous UI device (for example, a smart phone, a tablet, a desktop, and/or a notebook) other than the AR device 500 and is not optimized for the AR device (500), the application 511 may execute the element level task based on the XR object (hereinafter, a heterogeneous XR object).

In other words, in an embodiment, the application 511 may perform interactions according to a user's voice commands even with respect to XR objects for a heterogeneous UI device (that is, heterogeneous XR object).

Specifically, in an embodiment, the application 511 may acquire the task instruction audio data (hereinafter, heterogeneous UI-based the task instruction audio data) for commanding execution of preset specific functions for the heterogeneous XR object.

In this case, the heterogeneous UI-based the task instruction audio data according to an embodiment may include task command data that can be used on a heterogeneous UI device for which a predetermined heterogeneous XR object is optimized.

For example, the heterogeneous UI-based the task instruction audio data may include voice command data specialized for smartphones, desktops, and/or notebooks, such as “double-click,” “right-click to open the menu,” or “connect the link.”

Returning to the description, in an embodiment, the application 511 acquiring the heterogeneous UI-based the task instruction audio data may request a task authority for the heterogeneous XR object by interworking with the heterogeneous UI device for which the heterogeneous XR object is optimized.

Thereafter, in an embodiment, the application 511 acquiring the task authority from the heterogeneous UI device may interpret the natural language voice command according to the heterogeneous UI-based the task instruction audio data to perform interaction with the XR object (XRO).

Thus, in an embodiment, the application 511 may support control of functional operations of an XR objects (XRO) authored for a heterogeneous UI device (including UI elements and/or icons in the embodiment) through voice commands.

Accordingly, the application 511 may break down boundaries among various devices and increase integration between the augmented reality environment and other digital environments, thereby improving interoperability and providing a consistent user experience.

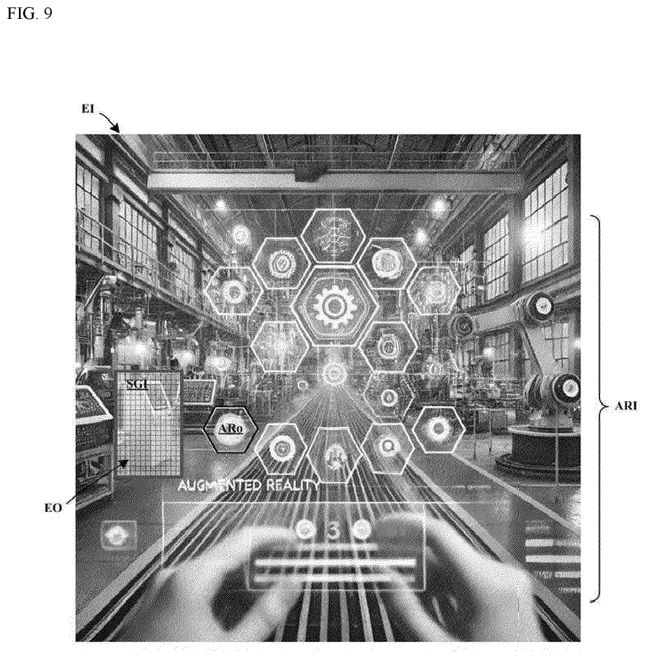

FIG. 9 is an illustrative diagram showing a method of providing and editing an XR external spatial object for an external image (EI) level task according to an embodiment of the present disclosure.

In addition, referring to FIG. 9, in an embodiment, the application 511 may execute the external image (EI) level task based on the XR spatial object SO.

Here, the external image (EI) level task according to an embodiment may include a task for determining a spatial entity based on the external image EI (hereinafter, an external spatial entity) and executing various task commands based on the determined external spatial entity.

Specifically, in an embodiment, the application 511 may provide an XR image (SGI; hereinafter referred to an XR external spatial guide image) showing a guide for determining an external spatial entity based on the XR spatial object SO.

For example, the application 511 may provide the XR external spatial guide image (SGI) showing, for example, a grid-type coordinate (position) selection guide with reference to the XR spatial object SO.

In addition, in an embodiment, the application 511 may acquire the task instruction audio data for specifying predetermined coordinates (position), region, and/or object with reference to the XR spatial object SO based on the XR external spatial guide image (SGI).

In addition, in an embodiment, the application 511 may interpret the natural language voice command according to the acquired the task instruction audio data to detect coordinates (position) and/or region within the external image EI corresponding to the predetermined coordinates (positions) and/or region with reference to the XR spatial object SO.

Further, in an embodiment, the application 511 may determine that the detected coordinates (position) and/or region within the external image EI is the external spatial entity.

In addition, in an embodiment, the application 511 may provide an XR external spatial object EO, which is the XR object (XRO) obtained by visualizing the determined external spatial entity.

In an embodiment, the application 511 may provide the XR external spatial object EO showing the external spatial entity in the form of a predetermined pointer and/or a region (for example, a rectangular or circular shape).

In addition, in an embodiment, the application 511 may execute the above-described external image (EI) level task based on the determined external spatial entity.

Specifically, in an embodiment, the application 511 may acquire the task instruction audio data for specifying a predetermined external image (EI) level task based on the external spatial entity.

In addition, in an embodiment, the application 511 may interpret the natural language voice command according to the acquired the task instruction audio data and execute a corresponding external image (EI) level task.

For example, the application 511 may execute the external image (EI) level task for performing, for example, execution of a task for providing, modifying, and/or an adding search information for the object corresponding to the external spatial entity in response to the task instruction audio data.

As a specific example, the application 511 may execute the above-described external image (EI) level task in response to the task instruction audio data such as “Tell me search information for the external spatial entity,” “Search for weather of a place at which the external spatial entity is present,” “Guide a hiking trail of a mountain next to the external spatial entity,” or “Tell me history related to the external spatial entity.”

Thus, in an embodiment, the application 511 may support a spatial-entity-based task associated with the external image EI to enable a continuous interaction between an augmented reality environment and a real-world view, thereby expanding a user experience.

Referring back to FIG. 6, as described above, in an embodiment, the application 511 may support the user to interact intuitively and efficiently in the augmented reality environment through execution of a task command based on the XR spatial object SO.

This makes it possible for the application 511 to increase convenience and productivity of augmented-reality-based interactions and greatly improve usability of the AR device 500.

As described above, in an embodiment of the present disclosure, the application 511 selects and edits the XR objects XRO and the spatial entity provided from the AR device 500 through the user's voice commands and increases interoperability with a heterogeneous UI device, thereby precisely controlling the AR device 500 intuitively and efficiently through voice without a separate controller or complex gestures.

Accordingly, the application 511 can directly improve the quality of the user interaction implemented in the augmented reality environment, and control performance.

### Method of Controlling AR Device Based on Gaze and Voice Command

Meanwhile, in situations such as a work site where there is significant noise and it is difficult to use gestures, a more user-friendly interface may be required.

The application 511 may allow the user to wear smart glasses and then register a user voice profile (formant frequency, timbre, decibel range, and the like) through simple utterance training, and may extract characteristics of the user voice profile and store a reference voice profile for user voice recognition.

For example, characteristics of a user's voice, such as a formant frequency, timbre, pronunciation habit, and an average decibel, may be extracted and stored through a machine learning model or a statistical algorithm.

Thereafter, the application 511 may determine a user voice recognition environment (S301).

Specifically, the application 511 may detect surrounding noise in real time through the microphone or the like included in the sensor system 160, 260, 360, or 460, and collect surrounding audio data.

Further, the application 511 may extract audio data related to the user voice from the collected surrounding audio data with reference to a preset reference voice profile.

Specifically, the application 511 may primarily extract, as voice-related audio, audio in which a weight is applied to a user voice band frequency for a general voice band.

Next, the application 511 may reflect reference voice profile characteristics of the user in the extracted voice-related audio to detect valid voice data for the user, and then extract the detected data as valid voice data.

Further, the application 511 may input the valid voice data to the voice AI agent to calculate a recognition rate for the voice data (for example, a matching rate with text during text conversion), and may perform a sound pickup environment setting when the calculated voice data recognition rate is equal to or lower than a preset level.

In addition, the application 511 may determine that an environment is noisy and perform the sound pickup environment setting when a surrounding noise level is equal to or greater than a specific reference value or when a decibel level of the voice-related audio is equal to or greater than a preset value.

The application 511 may perform the sound pickup environment setting according to the determined voice recognition environment (S303).

In an embodiment, the application 511 may perform the sound pickup environment setting according to a real-time voice recognition environment.

Specifically, the application 511 may perform the sound pickup environment setting based on a decibel level of real-time surrounding audio data and a decibel level of the valid voice data.

Specifically, the application 511 may calculate a difference between an average and/or peak decibel level of the valid voice data and a decibel level of the surrounding audio data other than the valid voice data, and determine a reference decibel level for filtering for the calculated decibel difference.

For example, the application 511 may determine the reference decibel level for filtering in proportion to a ratio of the decibel difference between the valid voice data and the surrounding audio data, and filter, as noise, audio data higher than the reference decibel level for filtering relative to an average decibel level of the valid voice data.

In this case, the application 511 may set a different reference decibel level for filtering for each frequency band according to user voice decibel characteristics (for example, a weight for a specific formant frequency section).

For example, the application 511 may set a first reference decibel level for filtering for a reference voice band to which a weight for the user voice decibel characteristics is applied, and set a second reference decibel level for filtering for remaining frequency bands. In this case, the first reference decibel level for filtering is set to be higher than the second reference decibel level for filtering so that the voice-related audio can be filtered as little as possible to improve a voice recognition rate.

For example, when the first reference decibel level for filtering is 60 dB and the second reference decibel level for filtering is 50 dB, audio falling within a range of 300 to 3400 Hz has a high likelihood of being regarded as valid voice when the audio is at 55 dB or higher, but audio in a band below 300 Hz or above 3400 Hz may be classified as noise even when a level of the audio exceeds 50 dB.

In addition, when the ratio of the decibel difference between the surrounding audio data and the valid voice data varies by a certain reference value or more, the application 511 may dynamically respond to a noise environment by changing a setting of the microphone itself.

For example, the application 511 may change a position of a sound pickup sensor of the microphone, a sound pickup direction of the sound pickup sensor, and/or a microphone gain according to the ratio of the decibel difference.

Specifically, the application 511 may change a position of the microphone. Using a microphone mounted on the AR device 500, a sensor direction may be finely adjusted to avoid a direction in which a loud noise occurs (for example, a machinery noise direction), or beamforming coefficients may be updated to increase sensitivity with respect to a user voice direction.

In addition, the application 511 may adjust a sound pickup direction of the microphone.

When the user voice and a noise sound are received from similar directions, and when a microphone array is present, the application 511 may update a weight matrix of a beamforming algorithm in real time to assign a directional gain to the user voice direction.

In addition, the application 511 may adjust the microphone gain.

Specifically, in an environment in which the decibel difference between the valid voice data and the surrounding audio data decreases or increases rapidly (for example, noise increases from 85 dB to 90 dB), the application 511 may automatically increase the microphone gain (or, conversely, decrease the gain when there is a clipping risk due to excessive gain) to maintain a voice recognition rate.

According to the above-described embodiments, the application 511 may flexibly respond to changes in a noise level, minimize a problem in which a user voice is distorted or lost due to noise, and improve voice recognition accuracy.

Next, the user voice recognition may be performed in the set sound pickup environment (S305).

The application 511 may acquire surrounding audio data of the user based on the applied optimized sound pickup environment setting, extract the user voice data from the acquired surrounding audio data, and then generate task data through the voice AI agent.

In an embodiment, the voice AI agent may include an automatic speech recognition module that converts a user's utterance audio data into text, and a natural language understanding module that extracts a user's intent and parameters from the converted text.

Specifically, the automatic speech recognition module may convert an input audio waveform into a mel-spectrogram and input the mel-spectrogram to an acoustic model for conversion into a text sequence. In addition, the natural language understanding module may embed the converted text sequence into a high-dimensional vector through an encoder, and the embedded vector may be branched into two sub-networks and processed.

In this case, an intent classifier, which is a first sub-network, may receive a vector of an entire sentence and classify an utterance intent of the user. A slot filler, which is a second sub-network, may perform tagging on each token in the sentence and extract specific attribute values. For example, when the user utters “Select the right red box,” the natural language understanding module may output an intent of “object selection” and slot information such as “position: right,” “color: red,” and “object type: box.”

The processor may use the extracted slot information as filtering conditions and search for an object that satisfies the conditions among objects present in a current field of view. When a confidence of an intent classification result is less than a reference value, the processor may perform control so that a feedback loop for re-querying the user is executed.

Specifically, the voice AI agent may include an automatic speech recognition (ASR) module that converts the user's utterance audio data into text, and a natural language understanding (NLU) module that extracts a user's intent and parameters from the converted text.

Here, the ASR module may convert the input audio waveform into a mel-spectrogram and input the mel-spectrogram to an acoustic model (for example, Conformer, DeepSpeech) for conversion into a text sequence.

In addition, the NLU module may embed the converted text sequence into a high-dimensional vector through a bidirectional encoder representations from transformers (BERT)-based encoder. Further, the embedded vector may be branched into two sub-networks and processed.

In addition, the intent classifier may receive a vector of an entire sentence and classify an utterance intent of the user. (For example, SELECT_OBJECT, MOVE_ENTITY, and GET_INFO).

In addition, the slot filler may perform inside-outside-beginning (IOB) tagging on each token (word) in the sentence to extract specific attribute values.

For example, when the user utters “Select the right red box,” the NLU module outputs structured data as follows:

Intent: SELECT_OBJECT
Slots: {Position: “Right”, Color: “Red”, Object_Type: “Box”}

Further, the processor may use the extracted slot information (the color and the position) as filtering conditions and search for an object that satisfies the conditions among objects present in the current field of view. When a confidence of an intent classification result is less than a reference value, the processor may execute a re-query feedback loop, such as “which object do you mean?”

Here, the task data may be utilized for a determination of the XR object (XRO) in combination with the XR image XRI or external image EI information, a command intent, context, and the like, and may be utilized as task command data for the determined XR object.

Further, the application 511 may perform user gaze tracking S306).

To this end, the application 511 may collect head tracking data and eye tracking data.

Specifically, when the user wears the AR device 500, the application 511 may track, in real time, a user head movement (head tracking) and gaze (eye tracking) through the sensor system 160, 260, 360, or 460 and generate the gaze tracking data.

Here, the gaze tracking data may include gaze vectors of left and right eyes of the user, a gaze intersection point, a gaze movement speed, and whether a gaze is fixed for a predetermined time.

In this case, the application 511 may display a gaze pointer matching the gaze tracking data as the XR spatial object SO obtained by visualizing the gaze pointer on the XR image XRI or the external image EI.

For intuitive gaze pointer control for the user, the application 511 may determine a layer to interface through head tracking and provide a gaze pointer control interface that points to a specific icon within the layer through eye tracking.

Here, the layer may be understood as an interface layer related to different functions or environments, such as a main interface screen, a sub-interface screen related to various themes, and an external image.

In addition, when the layer is a real space or a virtual space, the application 511 may determine a pointer position within a depth-based space according to the gaze within the space. Specifically, in order to discriminate to which XR object (XRO) eye tracking corresponds within the determined layer and space, the application 511 may determine a final gaze pointer position in consideration of depth information (for example, 3D coordinates and distance).

Specifically, the gaze pointer control interface may be configured to calculate an angle difference between a center point of each object and the gaze intersection point with respect to a plurality of objects or screen regions displayed on an augmented reality screen with reference to the gaze intersection point, and determine that an object or a screen region for which the angle difference is equal to or less than a preset threshold and the gaze is maintained for a predetermined time or more is an object selected by the user.

In addition, when an object does not exist around the gaze intersection point, a screen coordinate region including the gaze intersection point may be set as a spatial entity candidate.

In an embodiment, the processor may perform a ray-casting algorithm to select an object in a virtual space or an augmented reality space based on the gaze tracking data. Specifically, the processor may calculate a gaze vector and a gaze origin in a three-dimensional space using a center coordinate of a pupil and a corneal reflection point vector acquired from an eye tracking sensor.

In addition, the processor may project a virtual ray in a direction of the gaze vector from the gaze origin and perform an intersection test with a collision box assigned to each object in the augmented reality environment. In this case, the intersection test may be performed through a parametric equation such as [Equation 1] below.

P(t)=P_{origin}+t·V_{gaze}(where t>0) [Equation 1]

In addition, the processor may detect a plurality of object candidate groups that collide with the ray. In this case, to correct a user's gaze jitter and a minute movement of a pupil, the processor may apply a cone-casting scheme in which a center axis is the gaze vector rather than a single ray. Here, an inner angle of a cone may be variably set according to a user's skill level or UI density.

Furthermore, in order to determine a final target object, the processor may calculate an interest score for each object in the candidate group. The interest score may be defined as a weighted function using, as variables, (1) an angular deviation between the gaze vector and the center point of the object, (2) a distance from the user to the object, and (3) a dwell time of the gaze.

$${S}_{i} = {w}_{1} \cdot \frac{1}{δ + ϵ} + {w}_{2} \cdot \frac{1}{d} + {w}_{3} \cdot {T}_{dwell} \qquad [ Equation 2 ]$$

Here, w₁, w₂, and w₃ are weight coefficients, and ϵ may be a constant for preventing division by zero. The processor may determine that an object whose calculated interest score exceeds a preset threshold is an object finally gazed at by the user.

Such a gaze pointer may have a size or shape that is changed based on at least one of a size of a layer to be controlled, a size of an XR object inside the layer, and task characteristics.

Specifically, the application 511 may detect, from the XR image database of the embodiment described above, width, height, and overall screen scale information of the layer determined through head tracking.

For example, when the layer has a 2D GUI form, a size on X-Y coordinates (for example, in pixels) may be recognized, horizontal, vertical, and depth ranges in the space may be detected when the layer is a 3D XR space, and a size of the XR object (XRO) inside the layer and a size ratio of respective XR objects in the overall size may be calculated.

That is, the application 511 may determine a reference density of the interface depending on an actual size (in pixels or in a 3D space) of the XR object (XRO) or the UI element (icons, buttons, or the like) arranged inside the layer and an arrangement density (degree of spacing between objects).

Further, the application 511 may change a size and shape of the pointer depending on an overall size of the layer and the reference density of the interface.

In addition, the application 511 may determine, by the voice AI agent, what task the user is currently performing (precision operation, fast selection, general navigation, and the like) according to a program corresponding to each layer in accordance with the XR image database, and change a size and/or shape of the pointer.

Further, the application 511 may ascertain such layer characteristics and perform the following procedure to dynamically determine a size of the gaze pointer.

The application 511 sets a predefined size of a basic gaze pointer (for example, 2% of a screen width, or a diameter of 1 cm in a 3D space).

In this case, units may differ depending on whether the layer is a 2D interface or a 3D virtual space (pixels, cm, points, and the like).

When the layer is a very large screen (for example, a main screen with 4K resolution), and the gaze pointer remains at a reference value, the gaze pointer may appear too small or it may be difficult to ascertain a position.

On the other hand, when the layer is a small sub-screen and the gaze pointer is too large, the gaze pointer may obstruct the user's field of view.

Accordingly, the application 511 calculates a scaling ratio of the pointer size with reference to the overall size of the layer.

The application 511 may determine the size of the basic gaze pointer according to the overall layer size, and then correct a size of the gaze pointer to be inversely proportional to the reference density of the interface.

On the other hand, when a size of an object is large and spacing is wide, sufficiently clear selection is possible even when the pointer is kept large, and thus the pointer may be set to be slightly larger for pointer visibility (discernibility).

In addition, the application 511 may change the pointer size and shape according to whether a program of the layer requires a precision task.

Specifically, when the task characteristics of the layer are discriminated to be in a precision editing mode, the application 511 may reduce an overall size of the pointer and change the shape when the pointer becomes smaller than a preset value. That is, the application 511 may change the shape, including a body of the pointer and an edge included in the pointer, maintain a body size of the pointer to improve visibility, and induce precision tasks through the edge.

Next, the application 511 may determine an object according to gaze tracking information (S309).

In an embodiment, the application 511 may determine at least one object among the XR object (XRO), a real object, or a remote user avatar indicated by the calculated gaze pointer.

In this case, the application 511 may add position information of the gaze pointer to the text label information and the context data as in step S105 so that the voice AI agent determines an object more accurately.

Further, the application 511 may recognize the task instruction audio data for the determined object.

In an embodiment, the processor may drive a multimodal fusion engine that generates a final control command by combining the gaze tracking data with voice command data. The fusion engine may perform temporal synchronization and probabilistic combination.

Specifically, in a temporal synchronization process, the processor may set a time window with reference to the user's utterance point in time, extract a gaze data sequence collected within the time window, and select an object having a highest frequency or a longest dwell time as a primary candidate.

In addition, in a probabilistic combination process, the fusion engine may calculate a final target probability based on Bayesian inference. The final target probability may be calculated to be proportional to a product of an object probability based on the gaze and an object probability based on the voice.

P(Target)∝(Gaze|Object)×P(Voice|Object) [Equation 4]

For example, when gaze data has ambiguous values while moving between a first object and a second object and an attribute of the second object is input as a voice command, a probability value for the second object rises sharply. The fusion engine may select, as the final target, an object in which a product of the two probabilities is maximized.

More specifically, when the gaze moves between object A (blue ball) and object B (red box) and is ambiguous based only on the gaze data (P(Gaze|A≈P(Gaze|B)), and red color is input as a voice command, a value of P(Voice|B) rises sharply. The fusion engine selects, as the final target, an object in which a product of the two probabilities is maximized.

This makes it possible to generate a clear control command through mutual complementation between two modalities even when the gaze is inaccurate or the voice command is ambiguous.

Thereafter, the task instruction voice may be recognized from the valid voice data extracted when the object is determined and after the object is determined from the user (S311).

Further, the application 511 may determine the shape modification based on the XR spatial object SO, the element level task, the external image (EI) level task, and the like, based on the task instruction voice and the task data through the voice AI agent (see S113).

In addition, the application 511 may execute a task command for the object in response to the task instruction audio data (S313).

Specifically, the application 511 may perform control so that a task command can be executed for the determined XR object (XRO) in response to the recognized task instruction voice.

Examples thereof include “Make the XR icon larger” and “Open the right-click menu.” Even when an object is an XR object for a heterogeneous UI device, the application 511 of the present disclosure can execute commands through an interworking process.

Further, when the determined object is an avatar of a remote user and the voice AI agent determines, from an image database, a task instruction command for providing communication by interworking with the AR device 500 to the avatar of the remote user, the application 511 may perform a corresponding task.

For example, a remote collaboration function such as “Check position information of a remote avatar user” or “Connect voice chat with the avatar” may be performed.

In this case, the application 511 may continuously change the sound pickup environment setting according to the user voice recognition environment and support real-time voice conversation with the user of the AR device 500 of the other user even in a noisy environment. Specifically, the application 511 may transmit, to the AR device 500 of the other user, communication data, including the valid voice data extracted through the sound pickup environment setting according to the user voice recognition environment, so that noise is minimally delivered to the other user. In addition, in order for the other user to ascertain an on-site situation, filtered noise may be transmitted through another channel so that the on-site situation can be separately recognized.

Further, when an AR device 500 of another user is also in a voice recognition environment adjacent to the user, the application 511 may perform control so that the other user's voice can be extracted and output from audio data delivered to the other user according to the determined voice recognition environment.

First, voice-related data may be extracted from the audio data delivered to the other user with reference to the sound pickup environment setting of the user, a voice profile of the other user may be determined, and the other user's voice may be extracted and output as valid voice data according to the determined voice profile.

This makes it possible for the application 511 to perform a function of assisting communication between the user and the other user in a noisy environment.

In addition, when an object is a real object in the real world or a virtual object for a background in virtual reality, the application 511 may perform tasks such as “providing search information” and “generating an AR tag” for a physical place or an object displayed on the external image EI.

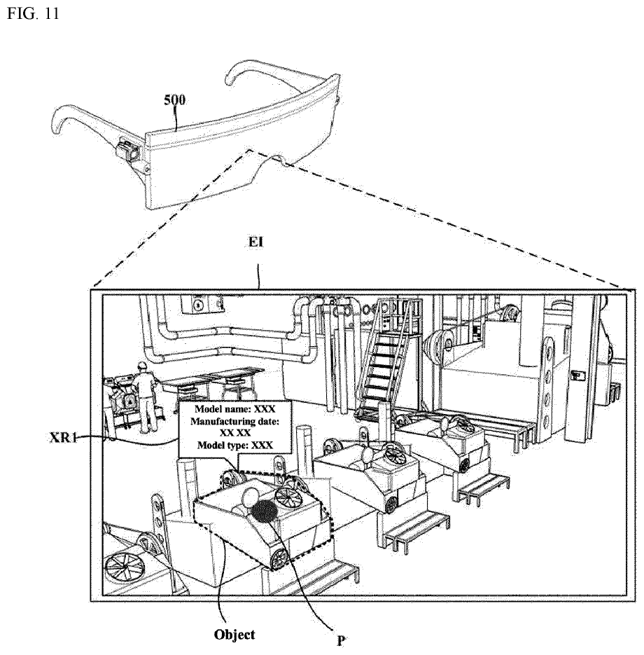

FIG. 11 illustrates a process of selecting an XR object according to a user's gaze according to an embodiment of the present disclosure.

Referring to FIG. 11, when a user wearing the AR device 500 looks at or points to a machine in the real world, the application 511 mounted in the device may recognize the machine, immediately search for related information, and overlay the information on the screen. For example, when text such as “model name: XXX and manufacturing date: XX XX” is displayed on the machine, and further, the user requests a detailed search through voice commands or hand gestures, the user may quickly check deep data such as maintenance history or part information. It is possible to improve task efficiency and safety in an industrial site by immediately identifying a machine in a real space and searching for necessary information in this manner.

In the AR device control method and system according to the embodiment of the present disclosure, it is possible to precisely control the AR device 500 intuitively and efficiently through voice without a separate controller or complex gestures by performing artificial-intelligence-based control of the AR device 500, based on the user's gaze and voice commands.

Further, in the AR device control method and system according to the embodiment of the present disclosure, it is possible to recognize the user's voice commands quickly and accurately in an environment in which noise occurs.

In addition, in the AR device control method and system according to the embodiment of the present disclosure, it is possible to ascertain the user's command intent quickly and accurately through the user's gaze and voice commands, thereby performing smooth control of smart glasses.

Accordingly, in the AR device control method and system according to the embodiment of the present disclosure, it is possible to remarkably improve the quality of a user experience based on the augmented reality environment, and control performance.

Meanwhile, the embodiments according to the present disclosure described above may be implemented in the form of program instructions that can be executed through various computer components and may be recorded on a computer-readable recording medium. The computer-readable recording medium may include program instructions, data files, data structures, and the like, alone or in combination. The program instructions recorded on the computer-readable recording medium may be specially designed and configured for the present disclosure, or may be known and available to those skilled in the computer software art. Examples of the computer-readable recording medium include a hardware device specially configured to store and execute program instructions, including a magnetic medium such as a hard disk, a floppy disk, and a magnetic tape, an optical recording medium such as a CD-ROM and a DVD, a magneto-optical medium such as a floptical disk, a ROM, a RAM, a flash memory, and the like. Examples of the program instructions include not only machine code produced by a compiler, but also high-level language code that can be executed by a computer using an interpreter or the like. Hardware devices may be modified into one or more software modules to perform processing according to the present disclosure, and vice versa.

1. A method of controlling an AR device, the method being performed by a voice AI agent application executed by at least one processor of the AR device, the method comprising:
tracking a user's gaze to generate gaze tracking data;
providing an object determination interface that determines an object according to the generated gaze tracking data;
determining an object selected by the user according to the provided object determination interface;
recognizing task instruction voice data for the determined object; and
executing a task command for the object in response to the task instruction voice data.

2. The AR device control method of claim 1, further comprising:
determining a voice recognition environment of the user; and
setting a sound pickup environment according to the determined voice recognition environment.

3. The AR device control method of claim 2, wherein the determining of the voice recognition environment of the user includes:
pre-registering a user voice profile;
collecting surrounding audio data of the AR device;
extracting valid voice data based on the user voice profile from the collected surrounding audio data; and
determining that a sound pickup environment setting based on a decibel difference of the surrounding audio data is performed when the valid voice data is discriminated to be lower than preset recognition accuracy.

4. The AR device control method of claim 3, wherein the performing of the sound pickup environment setting includes:
calculating a decibel difference between a decibel level of the valid voice data and a decibel level of the surrounding audio data other than the valid voice data;
determining a reference decibel level for filtering in proportion to the calculated decibel difference; and
filtering, as noise, audio data in a frequency band higher than the determined reference decibel level for filtering.

5. The AR device control method of claim 4, wherein the determining of the reference decibel level for filtering includes:
setting a first reference decibel level for filtering for a reference voice frequency band to which a weight for a user voice frequency characteristic of the voice profile is applied; and
setting a second reference decibel level for filtering lower than the first reference decibel level for filtering for remaining frequency bands.

6. The AR device control method of claim 1, wherein the performing of the sound pickup environment setting further includes
dynamically changing at least one of a sound pickup sensor position of a microphone, a sound pickup sensor direction, a beamforming algorithm weight, and a microphone gain according to a decibel difference ratio determined through the sound pickup environment setting.

7. The AR device control method of claim 1,
wherein the generating of the gaze tracking data includes controlling a sensor system of the AR device to sense head tracking data and eye tracking data, and
the providing of the object determination interface that determines the object includes
providing a layer determination interface for determining an interface target layer based on the head tracking data; and
providing an object selection interface for selecting an object included in the determined layer based on the eye tracking data.

8. The AR device control method of claim 1, wherein the providing of the object determination interface that determines the object includes:
displaying a gaze pointer as an XR object based on the gaze tracking data; and
dynamically changing a size or shape of the gaze pointer.

9. The AR device control method of claim 1, wherein the recognizing of the task instruction audio data includes processing a voice command for performing a remote collaboration function such as voice chatting or position information inquiry, by interworking with a remote user AR device when the determined object is a remote user avatar.

10. The AR device control method of claim 1, wherein the executing of the task command includes performing a task of generating an AR tag, providing search information, or inquiring maintenance history for the object on an external image when the determined object is a real physical object.

11. An AR device control method performed by a voice AI agent application executed by at least one processor of an AR device, the AR device control method comprising:
constructing an AR image database including a labeling data set for an AR object that is an object that supports user interaction based on an augmented reality environment;
acquiring voice AI agent task data including a predetermined AR image, external image, and voice command data;
determining an AR target object that is the AR object corresponding to the voice AI agent task data;
determining, based on the voice command data, a target spatial entity that is a spatial entity for the user interaction;
providing an AR spatial object that is the AR object obtained by visualizing the target spatial entity; and
executing a task command for the user interaction based on the AR spatial object.

12. The AR device control method of claim 11, wherein the AR object includes at least one of a UI element including all graphic elements supporting the user interaction based on the augmented reality environment, and an icon including an object configured of at least one UI element to intuitively deliver specific information.

13. The AR device control method of claim 11, wherein the determining of the AR target object includes:
detecting at least one AR object based on at least one of the AR image and the external image;
extracting label information for the at least one detected AR object from the AR image database;
identifying the AR object corresponding to the voice command data based on the extracted label information for the at least one AR object; and
determining the AR target object based on the identified AR object.

14. The AR device control method of claim 11, wherein the determining of the target spatial entity includes
acquiring voice input for designating at least one of a predetermined position and a predetermined region with reference to the AR target object;
targeting the spatial entity on at least one of the AR image and the external image based on the acquired voice input; and
determining that the targeted spatial entity is the target spatial entity.

15. The AR device control method of claim 14, wherein the determining of the target spatial entity further includes:
providing a guide for designating at least one of a predetermined position and a predetermined region with reference to the AR target object; and
acquiring the voice input based on the provided guide.

16. The AR device control method of claim 11, wherein the providing of the AR spatial object includes:
acquiring voice input for setting at least one of a position, size, shape, and detailed attribute of the AR spatial object; and
setting the AR spatial object based on the acquired voice input to edit the target spatial entity.

17. The AR device control method of claim 11, wherein the executing of the task command for the user interaction includes:
acquiring voice input for specifying the task command based on the AR spatial object; and
executing, based on the acquired voice input, a task of changing a shape of the AR object based on the AR spatial object.

18. The AR device control method of claim 11, wherein the executing of the task command for the user interaction includes:
acquiring voice input for specifying the task command based on the AR spatial object; and
executing, based on the acquired voice input, a task of performing a preset function on the AR object based on the AR spatial object.

19. The AR device control method of claim 11, wherein the executing of the task command for the user interaction includes:
acquiring voice input for specifying the task command based on the AR spatial object;
determining an external spatial entity that is the spatial entity with reference to the external image based on the acquired voice input; and
executing a task command for the user interaction based on the determined external spatial entity.
